(19) United States
(12) Patent Application Publication
(10) Pub. No.: US 2006/0097111 A1
(43) Pub. Date: May 11, 2006

(54) Methods and systems for rain removal and de-icing of monolithic windshields

(76) Inventors: Jeffrey H. Wood, Eureka, MO (US); Terry A. Sewell, Ballwin, MO (US)

Correspondence Address: Michael S. Smith;BLACK LOWE & GRAHAM PLLC, Suite 4800, 701 Fifth Avenue, Seattle, WA, 98104, US

(21) Appl. No.: 10/958,240

(22) Filed: Oct. 4, 2004

(51) Int. Cl. B64D 15/06

(52) U.S. Cl. 244/134 C

(57) ABSTRACT

Systems and methods for providing rain and ice removal on a windshield are. provided. The system may be implemented on a vehicle, such as an aircraft. In one embodiment, a system includes an injection molded windshield and a frame coupled to the injection-molded windshield and to the vehicle. The frame includes a channel that directs at least one of air or fluid onto an exterior surface of the windshield. The frame includes one or more one-way check valves. A fluid pump pumps fluid through the channel and onto the windshield. A reservoir stores de-icing fluid that is retrieved by the fluid pump. Air sources pump air through the channel and onto the one or more windshields. A controlling device controls the fluid pump or the air sources.

### FIELD OF THE INVENTION

This invention relates to aircraft design, and, more specifically, to rain removal and de-icing methods and systems for aircraft windshields.

### BACKGROUND OF THE INVENTION

A limiting factor in producing an aerodynamic forward fuselage is the planar cockpit windshield. The current window technology includes laminated windows that cannot be shaped with optimal aerodynamic curvature. The current glass ply laminates are planar and include windshield wipers for rain removal and integral heating plies for ice removal. The windshield wipers further reduce the aerodynamic efficiency of the forward fuselage.

Injection molded polycarbonate windshields can be shaped to enable the aerodynamic reshaping of the forward fuselage. This reshaping results in drag reduction unachievable with current glass-laminated flat windows. Injection molded aerodynamically shaped windshields include double curved surfaces that are not ideally shaped to accommodate typical windshield wipers that rely on a planar surface for intimate contact. Additionally, the very nature of reshaping the forward fuselage is to reduce drag. Windshield wipers disrupt clean airflow over the nose and induce drag and noise. Also, the injection-molded windshields are monolithic and do not include built-in laminated heating plies, therefore, they do not have ice removal capability that the current laminated glass windshields possess.

Therefore, there exists a need for aerodynamically-shaped fuselages with rain removal and de-icing capabilities that don't hinder aerodynamic properties.

### SUMMARY OF THE INVENTION

The present invention provides systems and methods for providing rain and ice removal on a windshield. The system may be implemented on a vehicle, such as an aircraft. In one embodiment, a system includes one or more injection molded windshields and a frame coupled to the one or more injection-molded windshields and to the vehicle. The frame includes a channel that directs at least one of air or fluid onto an exterior surface of the one or more windshields.

In accordance with further aspects of the invention, the frame includes one or more one-way check valves.

In accordance with other aspects of the invention, a fluid pump is provided for pumping fluid through the channel and onto the one or more windshields.

In accordance with still further aspects of the invention, a reservoir is provided for storing de-icing fluid that is retrieved by the fluid pump.

In accordance with yet other aspects of the invention, air sources are provided for pumping air through the channel and onto the one or more windshields.

In accordance with still another aspect of the invention, a controlling device is provided for controlling one or more of the fluid pump or the one or more air sources.

### BRIEF DESCRIPTION OF THE DRAWINGS

Preferred and alternate embodiments of the present invention are described in detail below with reference to the following drawings.

FIG. 1 illustrates a front view of the fuselage of an aircraft that includes rain removal and de-icing components formed in accordance with an embodiment of the present invention;

FIG. 2 illustrates a cut-away view of the fuselage section shown in FIG. 1 including components of the system for performing rain and de-ice removal; and

FIG. 3 is a side elevational view of an aircraft having a system in accordance with an alternate embodiment of the present invention.

### DETAILED DESCRIPTION

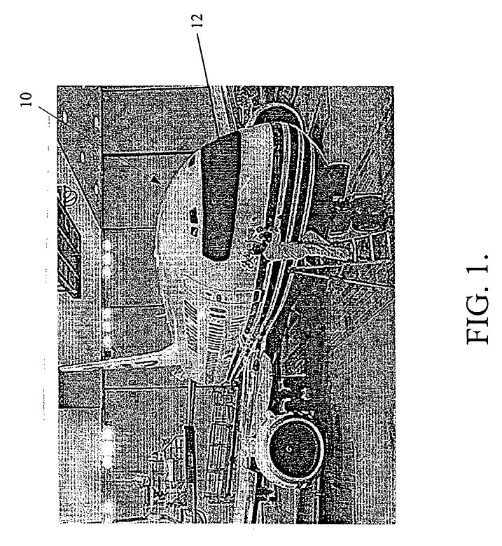

The present invention relates to advanced forward fuselage construction. Many specific details of certain embodiments of the invention are set forth in the following description and in FIGS. 1-3 to provide a thorough understanding of such embodiments. One skilled in the art, however, will understand that the present invention may have additional embodiments, or that the present invention may be practiced without several of the details described in the following description.

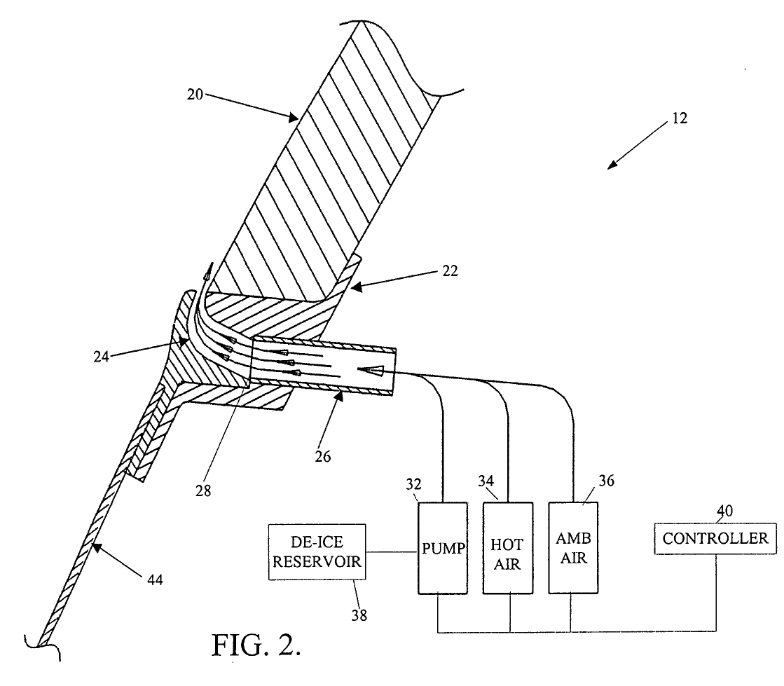

As shown in FIG. 1, an aircraft 10 includes a monolithic windshield system 12. The monolithic windshield system 12 includes one or more injection-molded windshields and rain removal and de-icing components. The rain removal and de-icing components are shown in more detail below in FIG. 2.

FIG. 2 illustrates a cross-sectional view of a portion of the monolithic windshield system 12. The monolithic windshield system 12 includes monolithic windshield 20, a frame 22, a plenum 24, a flow device 26, and a check valve 28. Although only one plenum 24, flow device 26, and check valve 28 are shown in FIG. 2, it will be appreciated that a plurality of these components will typically be used and may be distributed along selected portions of the perimeter of the windshield 20.

As further shown in FIG. 2, the system 12 also includes a supply pump 32, a heated air source 34, an ambient air source 36, a de-ice fluid reservoir 38, and a controller 40. The windshield 20 is attached to the frame 22 by fasteners and/or adhesives. The frame 22 is attached to one or more support members 44 of the aircraft. The frame 22 receives one or more flow devices 26 at an interior surface of the frame 22. The plenum 24 is formed within the frame 22 and is positioned to receive fluid flow from one or more of the flow devices 26. Included within the one or more plenums 24 or the flow devices 26 are one-way check valves 28 that allow fluid or air to flow in the direction from the interior or the aircraft to the exterior of the aircraft. The supply pump 32, heated air source 34, and ambient air source 36 are all coupled to the one or more of the flow devices 26.

The pump 32 retrieves de-icing fluid stored in the de-ice fluid reservoir 38 and pumps it through the flow devices 26, the check valves 28, and the plenums 24 and onto the windshield 20. The heated air source 34 transmits high pressure heated air through the flow devices 26, the check valves 28, the plenums 24 and onto the windshield 20. The ambient air source 36 transmits unheated, high pressure air through the flow devices 26, the check valves 28, the plenums 24 and onto the windshield 20. Hot air generation can be from various sources, such as passive Vortex tubes, ducted engine bleed air, or active in-line electric heating elements, such as HOTWATT Air Process Heaters. In one embodiment, air flow velocity may be approx 40,000 feet per minute (FPM).

As shown in FIG. 2, in this embodiment, the flow passage through the plenum 24 is representative of a generally converging flow duct that turns the flow and exhausts the flow through the plenum 24 approximately tangentially over the surface of the windshield 20 or commercial air handlers can by employed such as ARTX™ Air Curtain, ARTX™ High-Thrust Wedge Jet, WindJet® Air Knife, or Vortron's AirPower™ to introduce the airflow over the windshield 20. The flow passage through the plenum 24 may be designed to provide the desired degree of acceleration of the flow emanating from the pump 32 (or the heated air source 34 and ambient air source 36) to provide a suitable flow velocity onto the windshield 20. The duct or plenum 24 is bumped upward to alleviate any direct impingement of hot air on the windshield edge while at the same time create a “thermal blanket” for the localized deicing.

In another embodiment, the frame 22 receives a single flow device 26. The single flow device 26 supplies received high pressure air from the sources 34 or 36 or de-icing fluid from the pump 32 onto the windshield 20 through a single plenum 24. The single plenum 24 runs along the frame 22 below most or all of the bottom edge of the windshield 20.

The controller 40 is in signal communication with the supply pump 32, the heated air source 34, and the ambient air source 36 for controlling operation of each of those devices. The controller 40 might include a de-icing switch or a rain removal switch in the cockpit. The controller 40 may also include sensors for sensing when a condition exists that would require rain or ice removal, and a switch component for automatically controlling the supply pump 32, the heated air source 34, and the ambient air source 36 based on output of the sensors.

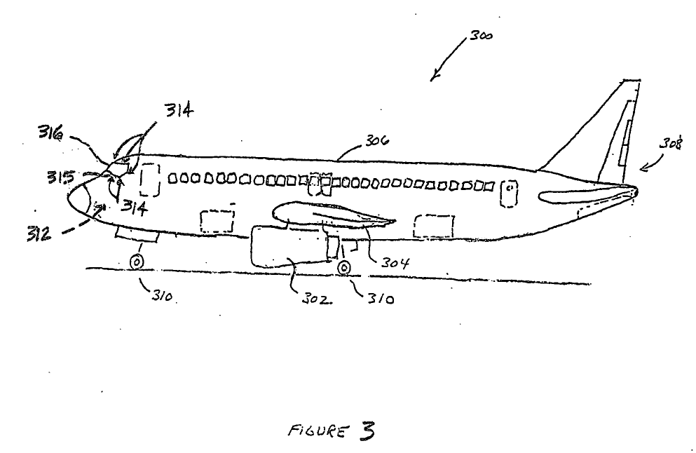

Those skilled in the art will also readily recognize that the foregoing embodiments may be incorporated into a wide variety of different systems. Referring now in particular to FIG. 3, a side elevation view of an aircraft 300 having one or more of the disclosed embodiments of the present invention is shown. With the exception of the embodiments of windshield de-icing systems 314 according to the present invention, the aircraft 300 includes components and subsystems generally known in the pertinent art, and in the interest of brevity, will not be described in detail.

As shown in FIG. 3, the aircraft 300 generally includes one or more propulsion units 302 that are coupled to wing assemblies 304, or alternately, to a fuselage 306 or even other portions of the aircraft 300. Additionally, the aircraft 300 also includes a tail assembly 308 and a landing assembly 310 coupled to the fuselage 306. The aircraft 300 further includes other systems and subsystems generally required for the proper operation of the aircraft 300. For example, the aircraft 300 includes a flight control system 312 (not shown in FIG. 3), as well as a plurality of other electrical, mechanical and electromechanical systems that cooperatively perform a variety of tasks necessary for the operation of the aircraft 300. The aircraft 300 further includes one or more of the embodiments of windshield de-icing systems 314 according to the present invention, which may be incorporated into various portions of the frame 315 disposed about the windshield 316 of the aircraft 300.

The aircraft 300 shown in FIG. 3 is generally representative of a commercial passenger aircraft, which may include, for example, the 737, 747, 757, 767 and 777 commercial passenger aircraft available from The Boeing Company of Chicago, Ill. In alternate embodiments, however, the various embodiments of the present invention may also be incorporated into flight vehicles of other types. Examples of such flight vehicles may include manned or even unmanned military aircraft, rotary wing aircraft, or even ballistic flight vehicles, as illustrated more fully in various descriptive volumes, such as Jane's All The World's Aircraft, available from Jane's Information Group, Ltd. of Coulsdon, Surrey, UK.

While preferred and alternate embodiments of the invention have been illustrated and described, as noted above, many changes can be made without departing from the spirit and scope of the invention. For example, the plenum 24 may be located around the windshield 20 along any of the edges of the frame 22 in order to supply high pressure air or de-icing fluid onto the surface of the windshield 20. Furthermore, a single flow device 26 may be used to provide flow to a plurality of plenums 24, or a plurality of flow devices 26 may be used to provide flow to a single plenum 24. Accordingly, the scope of the invention is not limited by the disclosure of these preferred and alternate embodiments. Instead, the invention should be determined entirely by reference to the claims that follow.

What is claimed is:

1. An aircraft comprising:
a fuselage;
wing assemblies and an empennage operatively coupled to the fuselage;
at least one propulsion unit operatively coupled to the fuselage;
one or more windshields;
a frame coupled to the one or more windshields and to the fuselage, the frame comprising:
a channel for directing at least one of air or fluid onto an exterior surface of the one or more windshields.

2. The aircraft of claim 1, wherein the frame includes one or more one-way check valves.

3. The aircraft of claim 1, further comprising:
a fluid pump for pumping fluid through the channel and onto the one or more windshields.

4. The aircraft of claim 3, further comprising:
a reservoir for storing fluid that is retrieved by the fluid pump.

5. The aircraft of claim 4, wherein the fluid stored in the reservoir is de-icing fluid.

6. The aircraft of claim 3, further comprising:
one or more air sources for pumping air through the channel and onto the one or more windshields.

7. The aircraft of claim 6, further comprising:
a controlling device for controlling one or more of the fluid pump or the one or more air sources.

8. The aircraft of claim 6, wherein the one or more air sources includes a heated air source of directing heated air through the channel onto the one or more windshields.

9. The aircraft of claim 6, wherein the one or more air sources includes an ambient air source of directing ambient air through the channel onto the one or more windshields.

10. A windshield system comprising:
one or more injection molded windshields;
a frame coupled to the one or more windshields and coupleable to a vehicle, the frame comprising:
a channel for directing at least one of air or fluid onto an exterior surface of the one or more windshields.

11. The system of claim 10, wherein the frame includes one or more one-way check valves.

12. The system of claim 10, further comprising:
a fluid pump for pumping fluid through the channel and onto the one or more windshields.

13. The system of claim 12, further comprising:
a reservoir for storing fluid that is retrieved by the fluid pump.

14. The system of claim 13, wherein the fluid stored in the reservoir is de-icing fluid.

15. The system of claim 12, further comprising:
one or more air sources for pumping air through the channel and onto the one or more windshields.

16. The system of claim 15, further comprising:
a controlling device for controlling one or more of the fluid pump or the one or more air sources.

17. The system of claim 15, wherein the one or more air sources includes a heated air source of directing heated air through the channel onto the one or more windshields.

18. The system of claim 15, wherein the one or more air sources includes an ambient air source of directing ambient air through the channel onto the one or more windshields.

19. A method of making a windshield system, the method comprising:
providing one or more windshields; and
coupling a frame to the one or more windshields,
wherein the frame includes a channel for directing at least one of air or fluid onto an exterior surface of the one or more windshields.

20. The method of claim 19, further comprising:
attaching one or more one-way check valves to the channel.

21. The method of claim 19, further comprising:
providing a fluid pump for pumping fluid through the channel and onto the one or more windshields.

22. The method of claim 21, further comprising:
providing a reservoir for storing fluid that is retrieved by the fluid pump.

23. The method of claim 22, further comprising:
storing de-icing fluid in the reservoir.

24. The method of claim 22, further comprising:
providing one or more air sources for pumping air through the channel and onto the one or more windshields.

25. The method of claim 24, further comprising:
providing a controlling device for controlling one or more of the fluid pump or the one or more air sources.

26. The method of claim 24, wherein the one or more air sources includes a heated air source for directing heated air through the channel onto the one or more windshields.

27. The method of claim 24, wherein the one or more air sources includes an ambient air source for directing ambient air through the channel onto the one or more windshields.
